(19) United States
(12) Patent Application Publication
(10) Pub. No.: US 2008/0103998 A1
(43) Pub. Date: May 1, 2008

(54) Method for Generating Multiple Orthogonal Support Vector Machines

(76) Inventor: Kevin E. Gates, Queensland (AU)

Correspondence Address: JOHN ALEXANDER GALBREATH, 2516 CHESTNUT WOODS CT, REISTERSTOWN, MD, 21136, US

(21) Appl. No.: 11/722,793

(22) PCT Filed: Dec. 23, 2005
(86) PCT No.: PCT/AU05/01962

§ 371 Date: Jun. 29, 2007

(30) Foreign Application Priority Data
Dec. 24, 2004 (AU) 2004907341

(51) Int. Cl. G06F 15/18

(52) U.S. Cl. 706/12

(57) ABSTRACT

A method is provided of operating a computer to enhance extraction of information associated with a first training set of vectors for a decision machine, such as a classification Support Vector Machine (SVM). The method includes operating the computer to perform the steps of: (a) forming a plurality of mutually orthogonal training sets from said first training set; (b) training each of a plurality of classification support vector machines with a corresponding one of the plurality of mutually orthogonal training sets; and (c) classifying one or more test vectors with reference to the plurality of classification support vector machines. The invention is applicable where the feature space from which the first training set is derived exceeds the true dimensionality associated with the classification problem to be addressed.

### FIELD OF THE INVENTION

The present invention is concerned with learning machines such as Support Vector Machines (SVMs).

### BACKGROUND TO THE INVENTION

The reference to any prior art in this specification is not, and should not, be taken as an acknowledgement or any form of suggestion that the prior art forms part of the common general knowledge.

A decision machine is a universal learning machine that, during a training phase, determines a set of parameters and vectors that can be used to classify unknown data. An example of a decision machine is the Support Vector Machine. A classification Support Vector Machine (SVM) is a universal learning machine that, during a training phase, determines a decision surface or “hyperplane”. The decision hyperplane is determined by a set of support vectors selected from a training population of vectors and by a set of corresponding multipliers. The decision hyperplane is also characterised by a kernel function.

Subsequent to the training phase the classification SVM operates in a testing phase during which it is used to solve a classification problem in order to classify test vectors on the basis of the decision hyperplane previously determined during the training phase.

Support Vector Machines find application in many and varied fields. For example, in an article by S. Lyu and H. Farid entitled “Detecting Hidden Messages using Higher-Order Statistics and Support Vector Machines” (5th International Workshop on Information Hiding, Noordwijkerhout, The Netherlands, 2002) there is a description of the use of an SVM to discriminate between untouched and adulterated digital images.

Alternatively, in a paper by H. Kim and H. Park entitled “Prediction of protein relative solvent accessibility with support vector machines and long-range interaction 3d local descriptor” (Proteins: structure, function and genetics, 2004 Feb. 15; 54(3):557-62) SVMs are applied to the problem of predicting high resolution 3D structure in order to study the docking of macro-molecules.

The mathematical basis of a SVM will now be explained. An SVM is a learning machine that given m input vectors x∈ [symbol] , drawn independently from the probability distribution function p(x) with an output value yᵢ, for every input vector xᵢ, returns an estimated output value ƒ(xᵢ)=yᵢ for any vector xᵢ, not in the input set.

The (xᵢ, yᵢ) i=0, . . . m are referred to as the training examples. The resulting function ƒ(x) determines the hyperplane which is then used to estimate unknown mappings. Each of the training population of vectors is comprised of elements or “features” of a feature space associated with the classification problem.

FIG. 1, illustrates the above training method. At step 24 the support vector machine receives vectors xᵢ of a training set each with a pre-assigned class yᵢ. At step 26 the vector machine transforms the input data vectors xᵢ by mapping them into a multi-dimensional space. Finally at step 28 the parameters of the optimal multi-dimensional hyperplane defined by ƒ(x) is determined. Each of steps 24, 26 and 28 of FIG. 1 are well known in the prior art.

With some manipulations of the governing equations the support vector machine can be phrased as the following Quadratic Programming problem:

| | | |
|---|---|---|
| min W(α) = | ½ α^{T}Ωα − α^{T}e | (1) |
| where | Ω_{i,j} = yᵢyⱼK(xᵢ,xᵢ) | (2) |
| | e = [1, 1, 1, 1, ...., 1]^{T} | (3) |
| Subject to | 0 = α^{T}y | (4) |
| | 0 ≦ αᵢ ≦ C | (5) |
| where | C is some regularization constant. | (6) |

The K(xᵢ,xᵢ) is the kernel function and can be viewed as a generalised inner product of two vectors. The result of training the SVM is the determination of the multipliers αᵢ.

Suppose we train a SVM classifier with pattern vectors xᵢ, and that r of these vectors are determined to be support vectors, Denote them by xᵢ, i=1, 2, . . . , r. The decision hyperplane for pattern classification then takes the form

$$f ( x ) = {\sum }_{i}^{r} {α}_{i} {y}_{i} K ( x , {x}_{i} ) + b \qquad ( 7 )$$

where αᵢ is the Lagrange multiplier associated with pattern xᵢ and K(.,.) is a kernel function that implicitly maps the pattern vectors into a suitable feature space. The b can be determined independently of the αᵢ. FIG. 2 illustrates in two dimensions the separation of two classes by hyperplane 30. Note that all of the x's and o's contained within a rectangle in FIG. 2 are considered to be support vectors and would have associated non-zero αᵢ.

Given equation (7) an un-classified sample vector x may be classified by calculating ƒ(x) and then returning −1 for all returned values less than zero and 1 for all values greater than zero.

FIG. 3 is a flow chart of a typical method employed by prior art SVMs for classifying vectors xᵢ of a testing set. At box 34 the SVM receives a set of test vectors. At box 36 it transforms the test vectors into a multi-dimensional space using support vectors and parameters in the kernel function. At box 38 the SVM generates a classification signal from the decision surface to indicate membership status, member of a first class “1” or of a second class “−1”, of each input data vector. At box 40 a classification signal is output, e.g. displayed in a computer display. Steps 34 through 40 are described in the literature and accord with equation (7).

As previously mentioned, each of the training population of vectors is comprised of elements or “features” that correspond to features of a feature space associated with the classification problem. The training set may include hundreds of thousands of features. Consequently, compilation of a training set is often time consuming and may be labour intensive. For example, to produce a training set to assist in determining whether or not a subject may be likely to develop a particular medical condition may involve having thousands of people in a particular demographic fill out a questionnaire containing tens or even hundreds of questions. Similarly to generate a training set for use in classifying email messages as likely to be spam or not-spam typically involves the processing of thousands of email messages.

It will be realised that given that there is often a considerable overhead involved in compiling a training set it would be advantageous to enhance the extraction of information associated with the training set.

It is an object of the invention to provide a method that enhances the extraction of information associated with a training set for a decision machine.

### SUMMARY OF THE INVENTION

Where the feature space from which the training vectors are derived exceeds the true dimensionality associated with the classification problem to be addressed, then a number of sets of training vectors might be derived. The present inventor has conceived of a method for enhancing information extraction from a training set that involves forming a plurality of mutually orthogonal training sets. As a result the classifications made by each decision machine are totally independent of each other so that the chance of correct classification after multiple machines is maximized.

According to a first aspect of the present invention there is provided a method of operating at least one computational device to enhance extraction of information associated with a first training set of vectors, the method including operating said computational device to perform the step of:

(a) forming a plurality of mutually orthogonal training sets from said first training set.

The method will preferably include the step of:

(b) training each of a plurality of decision machines with a corresponding one of the plurality of mutually orthogonal training sets.

The method may also include the step of:

(c) extracting information about one or more test vectors with reference to the plurality of decision machines.

In a preferred embodiment the plurality of decision machines comprises a plurality of support vector machines.

### In a preferred embodiment the step of extracting information comprises classifying the one or more test vectors with reference to the plurality of support vector machines.

Step (a) will usually include:

(i) centering and normalizing the first training set.

In the preferred embodiment step (a) includes:

(ii) iteratively solving a minimization problem with respect to a floating vector and with reference to the first training set to thereby determine a feature selection vector;

wherein iterations of the floating vector are derived from previous iterations of the feature selection vector so that an iteration of the floating vector and a previous iteration of the feature selection vector are orthogonal.

The minimization problem will preferably comprise a least squares problem.

Step (a) may further include:

(iii) setting elements of the features selection vector to zero in the event that they fall below a threshold value.

The method will preferably also include:

(iv) setting elements of a next iteration of the floating vector to zero in the event that they correspond to above-threshold elements of a current iteration of the feature selection vector.

Preferably the method includes:

(v) applying iterations of the feature selection vector to the first training set to thereby form the plurality of mutually orthogonal training sets.

Step (a) may also include:

flagging termination of the method in the event that at least a predetermined number of elements of the feature selection vector are less than a predetermined tolerance.

The method may further include:

programming at least one computational device with computer executable instructions corresponding to step (a) and storing the computer-executable instructions on a computer readable media.

According to a further aspect of the invention there is provided a method of operating at least one computational device to enhance extraction of information associated with a first training set of vectors, the method including operating said computational device to perform the step of:

(a) forming a plurality of mutually orthogonal training sets from said first training set;

(b) training each of a plurality of classification support vector machines with a corresponding one of the plurality of mutually orthogonal training sets; and

(c) classifying one or more test vectors with reference to the plurality of classification support vector machines.

In another aspect of the present invention there is provided a computer software product in the form of a media bearing instructions for execution by one or more processors, including instructions to implement the above described method.

According to a further aspect of the present invention there is provided a computational device programmed to perform the method. The computational device may for example be any one of the following.
a personal computer;
a personal digital assistant;
a diagnostic medical device; or
a wireless device.

Further preferred features of the present invention will be described in the following detailed description of an exemplary embodiment wherein reference will be made to a number of figures as follows.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a flowchart depicting a training phase during implementation of a prior art support vector machine.

FIG. 2 is a diagram showing a number of support vectors on either side of a decision hyperplane.

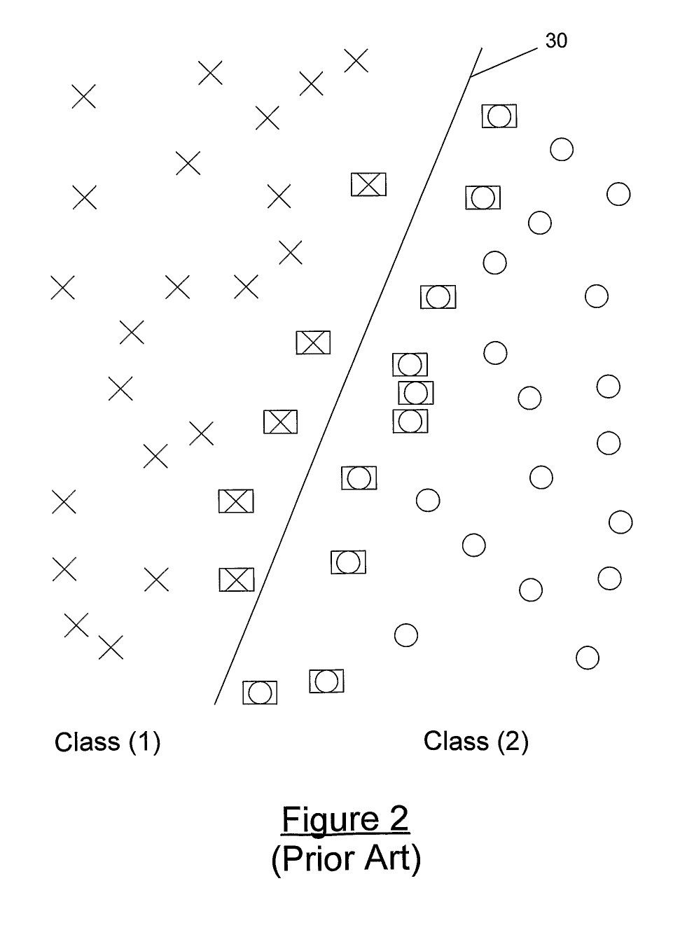

FIG. 3 is a flowchart depicting a testing phase during implementation of a prior art support vector machine.

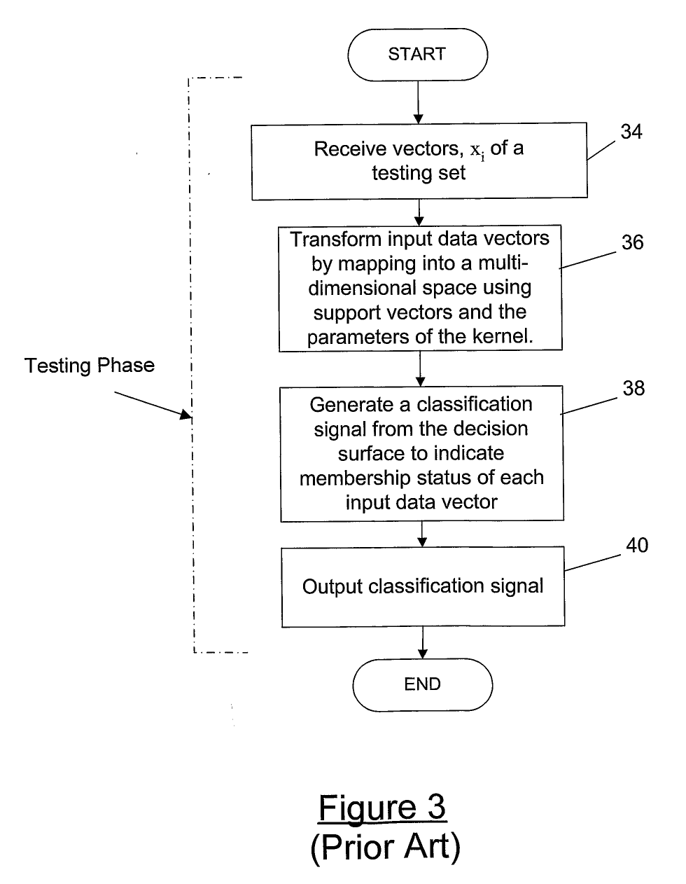

FIG. 4 is a flowchart depicting a training phase method according to a preferred embodiment of the present invention.

FIG. 5 is a flowchart depicting a testing phase method according to a preferred embodiment of the present invention.

FIG. 6 is a flowchart depicting a method according to a first embodiment of the present invention.

FIG. 6A is a flowchart depicting a method according to a further embodiment of the invention.

FIG. 7 is a block diagram of a computer system for executing a software product according to the present invention.

### DETAILED DESCRIPTION OF EXEMPLARY EMBODIMENTS

The present inventor has realised that a method for feature selection in the case of non-linear learning systems may be developed out of a least-squares approach. The minimization problem of equations (1-3) is equivalent to

$$\begin{matrix}Minimise \\ α\end{matrix} {‖ K α - e ‖}_{2}^{2} \qquad ( 8 )$$

where the (ij) entry in K is K(xᵢ, xⱼ), α is the vector of Lagrange multipliers and e is a vector of ones. The constraint equations (4-6) will also apply to (8). The notation outside the norm symbol indicates that it is the square of the 2-norm that is to be taken. The theory for a linear kernel where K(xᵢ, xⱼ)=xᵢ^{T}·xⱼ is a simple inner product of two vectors will now be developed. Writing the input vectors as a matrix: X=[xₗ, . . . , xₖ] it follows that e=X^{T}b for some floating vector b. The problem set out above in (8) can then be rewritten as:

$$\begin{matrix}Minimise \\ α\end{matrix} {‖ {X}^{T} X α - {X}^{T} b ‖}_{2}^{2} \qquad ( 9 )$$

This is the normal equation formulation for the solution of

$$\begin{matrix}Minimise \\ α\end{matrix} {‖ X α - b ‖}_{2}^{2} \qquad ( 10 )$$

so that (9) and (10) are equivalent. The first step in the solution of (10) is to solve the underdetermined least squares problem that will have multiple solutions

$$\begin{matrix}Minimise \\ b\end{matrix} {‖ {X}^{T} b - e ‖}_{2}^{2} \qquad ( 11 )$$

any solution is sufficient. However the desired and feasible solution is

$$b = P [ \begin{matrix}{b}_{1} \\ {b}_{2}\end{matrix} ] \qquad ( 12 )$$

where P is an appropriate pivot matrix and b₂=0. The size of b₂ is determined by the rank of the matrix X, or the number of independent columns of X. Any method that gives a minimum 2-norm solution and meets the constraints of the SVM problem may be used to solve (12). It is in the solution of (11) that an opportunity for natural selection of the features arises since only the nonzero elements contribute to the solution. For example, suppose that the solution of (11) is bₘᵢₙ and that the non-zero elements of bₘᵢₙ=[b₁, . . . , bₙ]^{T} are b₁₀₀, b₁, b₁₉₁, b₂₀₂, b₃₂₃, b₃₄₄, etc. In that case only features x_{i,100}, x_{i,1}, x_{i,191}, x_{i,202}, x_{i,323}, x_{i,344} etc. are used in the matrix X. The other features that make up X can be safely ignored without changing the performance of the SVM. Consequently, bₘᵢₙ may be referred to as a “feature selection vector”.

Numerically the difference between a zero element and a small element less than a predetermined minimum threshold value is negligible. For a computer implementation, all those elements less than the threshold can be disregarded without reducing the accuracy of the solution to the minimization problem set out in equation (8), and equivalently equation (9).

A second motivation for this approach is the fact that equation (9) contains inner products that can be used to accommodate the mapping of data vectors into feature space by means of kernel functions. In this case the X matrix becomes [Φ(x₁), . . . , Φ(xₙ)] so that the inner product X^{T}X in (9) gives us the kernel matrix. The problem can therefore be expressed as in (8) with e=Φ(x)·Φ(b). To find b we must then solve the optimisation problem

$$\begin{matrix}Minimise \\ b\end{matrix} {‖ Φ ( x ) \cdot Φ ( b ) - e ‖}_{2}^{2} \qquad ( 13 )$$

where Φ(x)·Φ(b) is computed as K(xᵢ, b).

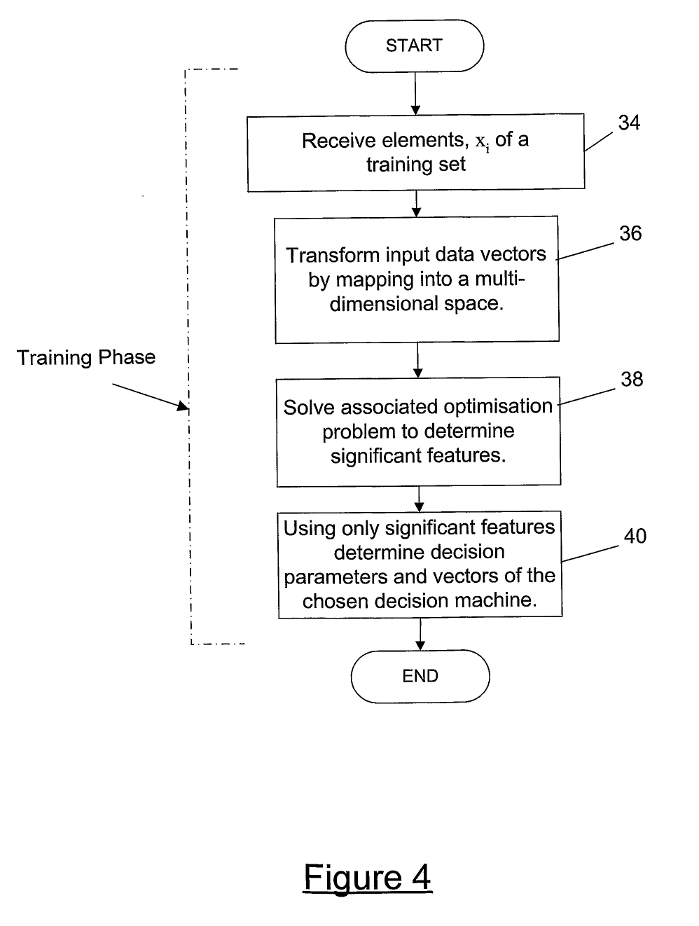

Thus the method can be readily extended to kernel feature space in order to provide a direct method for feature selection in non-linear learning systems. A flowchart of a method incorporating the above approach is depicted in FIG. 4. At box 35 the SVM receives a training set of vectors xᵢ. At box 37 the training data vectors are mapped into a multi-dimensional space, for example by carrying out equation (2). At box 39 an associated optimisation problem (equation 13) is solved to determine which of the features, i.e. elements, making up the training vectors are significant. This step is described with reference to equations (8)-(12) above. At box 41 the optimal multi-dimensional hyperplane is defined using training vectors containing only the active features through the use of equations (1) to (6) with the reduced feature set.

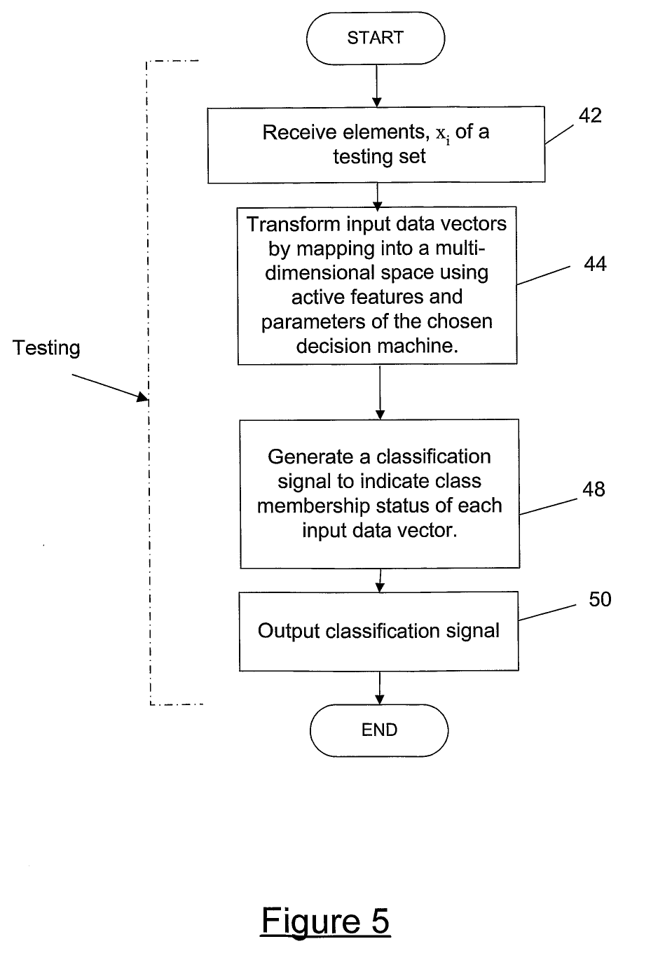

FIG. 5 is a flowchart of a method for classifying vectors. Initially at box 42 a set of test vectors is received. At box 44, when testing an unclassified vector, there is no need to reduce the unclassified vector to just its active features, the operations inclusive in the inner product K(xᵢ,x) will automatically use only the active features.

At box 48 a classification for the test vector is calculated. The test result is then presented at box 50.

In the Support Vector Regression problem, the set of training examples is given by (x₁, y₁), (x₂, y₂), . . . ,(xₘ, yₘ), xᵢ ∈ [symbol] ; where yᵢ may be either a real or binary value. In the case of yᵢ ∈{±1}, then either the Support Vector Classification Machine or the Support Vector Regression Machine may be applied to the data. The goal of the regression machine is to construct a hyperplane that lies as “close” to as many of the data points as possible. With some mathematics the following quadratic programming problem can be constructed that is similar to that of the classification problems and can be solved in the same way.

Minimise ½λ^{T}Dλ−λ^{T} (14)

subject to

λ^{T}g=0

0≦λᵢ≦C

where

$$λ = ⌊ {α}_{1} , {α}_{2} , … , {α}_{m} , {α}_{1}^{*} , {α}_{2}^{*} , … , {α}_{m}^{*} ⌋$$

$$D = ⌊ \begin{matrix}K ( {x}_{i} , {x}_{j} ) & - K ( {x}_{i} , {x}_{j} ) \\ - K ( {x}_{i} , {x}_{j} ) & K ( {x}_{i} , {x}_{j} )\end{matrix} ⌋$$

$$c = [ {y}_{1} - ɛ , {y}_{2} - ɛ , … , {y}_{m} - ɛ , - {y}_{1} - ɛ , - {y}_{2} - ɛ , … , - {y}_{m} - ɛ ]$$

$$g = [ \underbrace{1 , 1 , … , 1 ,}_{m} \underbrace{1 , 1 , … , 1}_{n} ]$$

This optimisation can also be expressed as a least squares problems and the same method for reducing the number of features can be used.

Where the feature space from which the training vectors are derived exceeds the true dimensionality associated with the classification problem to be addressed, then a number of sets of support vectors might be derived. Consequently a number of different decision machines, such as support vector machines (SVMs) can be constructed each defining a different decision hyperplane.

For example, if SVM₁ has a decision surface ƒ₁(x) and SVM₂ has a decision surface ƒ₂(x) then the classification of a test vector might be made by using ƒₛ(x)=ƒ₁(x)+ƒ₂(x). More generally, a decision surface ƒₛ(x) can be derived from SVMs SVM₁, . . . , SVMₙ defining respective decision hyperplanes ƒ₁(x), . . . , ƒₙ(x) as ƒₛ(x)=β₁*ƒ₁(x)+β₂*ƒ₂(x)+, . . . , +βₙ*ƒₙ(x) where the β are scaling constants. Alternatively, confidence intervals associated with the classification capability of each of the SVM₁, . . . , SVMₙ might be calculated and the best estimating SVM used.

A problem arises however in that it is not apparent how the sets of test vectors that are used to train each of the SVMs might be selected in order to improve the classification performance of the composite decision surface ƒₛ(x).

As previously mentioned, the present inventor has realised that it is advantageous for the SVM training data sets to be orthogonal to each other. By “orthogonal” it is meant that the features composing the vectors which make up the training set used for classification in one SVM are not evident or used in the second and successive machines. As a result the classifications made by each SVM are totally independent of each other so that the chance of correct classification after multiple machines is maximized. Mathematically

[Xⁿ]^{T}X^{m≠n}=[0] (15)

where Xⁿ and X^{m} are training data sets, in the form of matrices, derived from a large training data set and [0] is a matrix of zeroes. That is, the training sets that are derived are mutually orthogonal.

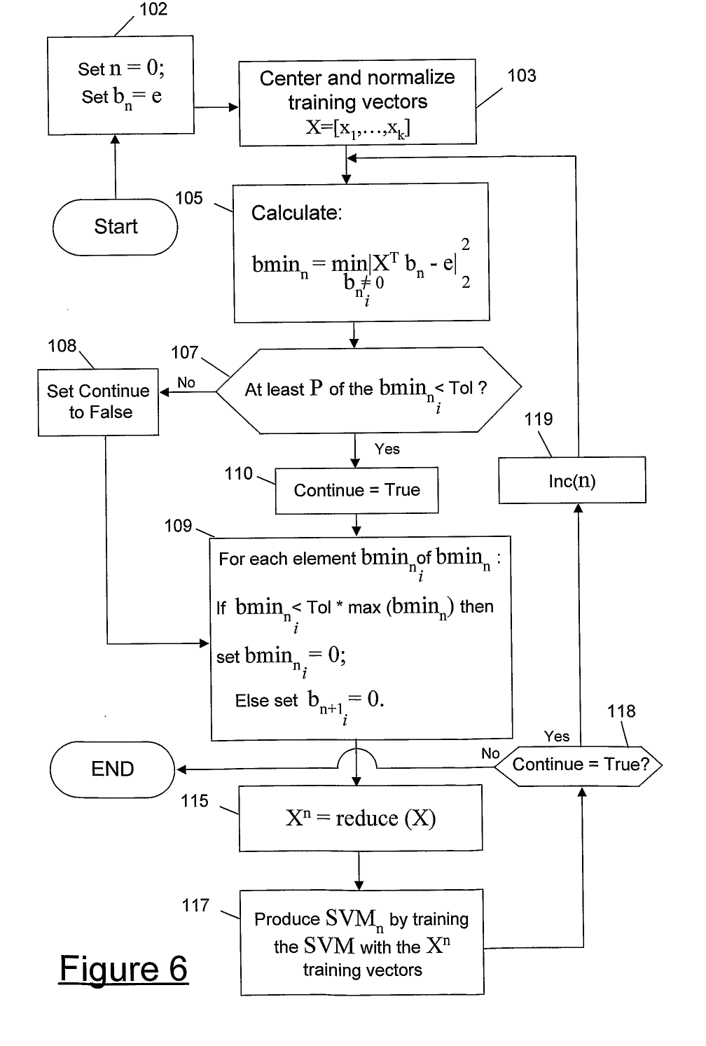

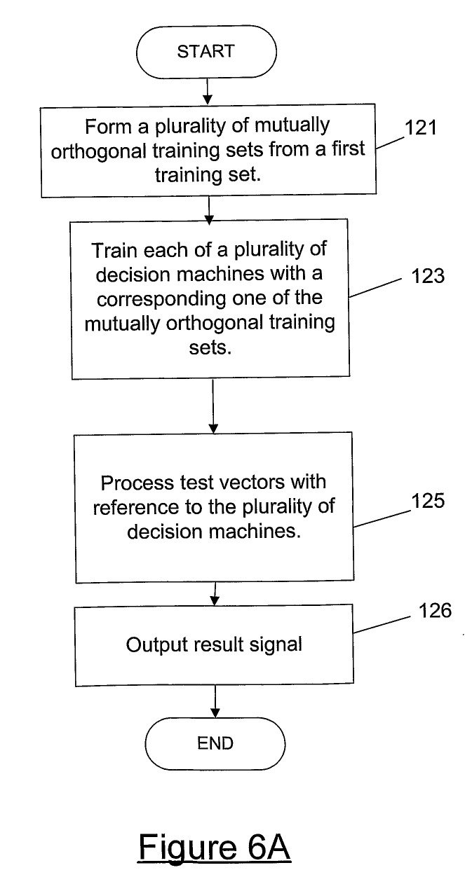

FIG. 6 is a flowchart of a method according to a preferred embodiment of the present invention for deriving the mutually orthogonal training sets.

At box 102 of FIG. 6 a counter variable n, is set to zero and vector bₙ is initialised to e=[1,1, . . . ,1]. At box 103 the total set of training vectors, written as a matrix X=[x₁, . . . , xₖ] is centered and normalized according to standard support vector machine techniques.

At box 105 the feature selection method that was previously described is applied to calculate:

$$b {min}_{n} = \begin{matrix}Minimise \\ b\end{matrix} {‖ {X}^{T} {b}_{n} - e ‖}_{2}^{2} \qquad ( 16 )$$

### This minimization is only carried out with respect to those elements of floating vector bₙ which are non-zero.

At box 107 each of the elements of bminₙ are compared to a predetermined tolerance, for example the maximum element of bminₙ i.e. max(bminₙ) multiplied by an arbitrary scaling factor “tol”. Here tol is a relatively small number. If it is the case that at least P (where P is an appropriate integer value) of the elements of bminₙ are less than tol then the procedure progresses to box 110 where the Boolean variable “Continue” is set to True. Alternatively, if less than P of the elements of bminₙ are less than or equal to tol then the procedure proceeds to box 108 where Continue is set to False. In either event, the procedure then progresses to box 109.

At box 109 the significant elements of bminₙ are determined by comparing each element to a threshold being tol multiplied by the largest element of bminₙ. The below-threshold elements of bminₙ are set to zero. Elements of a new floating vector, bₙ₊₁ corresponding to the above-threshold elements of bminₙ are also set to zero. The inner product of bₙ₊₁ and bminₙ will then be zero indicating that they are orthogonal vectors.

At box 115 a sub-matrix of training vectors Xⁿ is produced by applying a “reduce” operation to X. The reduce operation involves copying the elements of X to Xⁿ and then setting to zero all the x_{j,i} elements of Xⁿ corresponding to elements of bₙ that equal zero. This operation effectively removes rows from the Xⁿ sub-matrix. Alternatively, in another embodiment rather than setting to zero all the x_{j,i} elements of Xⁿ corresponding to elements of bₙ that equal zero the x_{j,i} elements of Xⁿ are instead removed so that the rank of the matrix Xⁿ is less than that of X.

At box 117 a support vector machine is trained with the Xⁿ training set to produce an SVM that defines the first hyperplane ƒₙ₌₁(x).

The procedure then progresses to decision box 118. If the Continue variable was previously set to true at box 110 then the procedure progresses to box 119. Alternatively, if the Continue box was previously set to False at box 108 then the procedure terminates.

At box 119 the counter variable n is incremented, and the procedure then proceeds through a further iteration from box 105. So long as at least P elements of bminₙ are greater than threshold, i.e. tol*max(bminₙ), at box 107, the method will continue to iterate. With each iteration a new SVM is trained from a subset training set matrix Xⁿ, which is orthogonal to the previously generated training sets, to determine a new hyperplane ƒₙ(x).

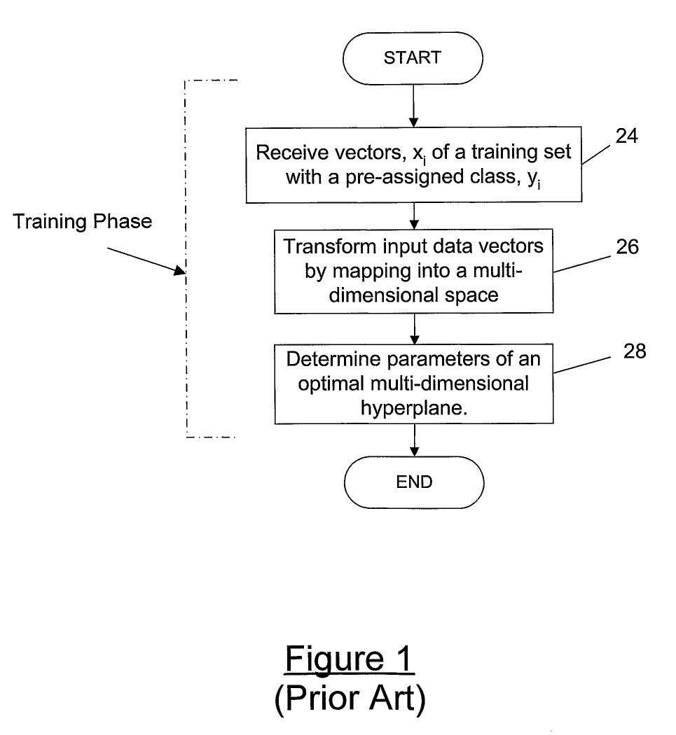

Since the features selected from X in each iteration of the procedure are always different, the SVM models will, due to the constraint in box 105 of FIG. 1, always be orthogonal.

FIG. 6A is a flowchart depicting a method of operating one or more computational devices according to a further embodiment of the present invention. At box 121 a plurality of mutually orthogonal training sets are produced from a first training set using the method described with reference to FIG. 6. At box 123 each of a plurality of decision machines, e.g. classification SVMs, is trained with a corresponding one of the mutually orthogonal training sets. At box 125 test vectors are processed with reference to the plurality of decision machines. This step will typically involve classifying test vectors. At box 126 a signal is output to notify a user of the results of box 125. The step at box 126 will typically involve displaying the results on the display of the computational device.

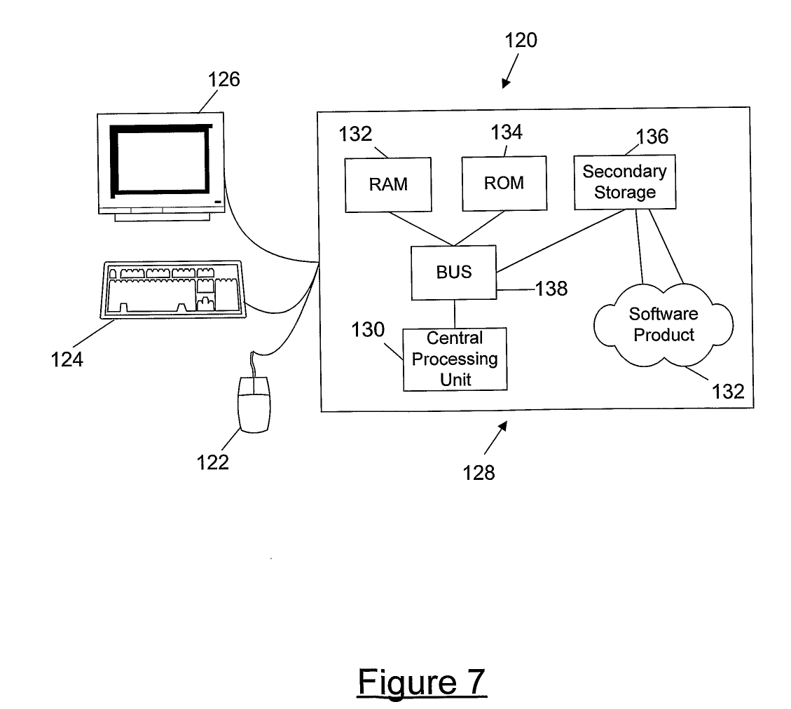

FIG. 7 depicts a computational device in the form of a conventional personal computer system 120 for implementing a method according to an embodiment of the present invention. Personal Computer system 120 includes data entry devices in the form of pointing device 122 and keyboard 124 and a data output device in the form of display 126. The data entry and output devices are coupled to a processing box 128 which includes at least one processor 130. Processor 130 interfaces with RAM 132, ROM 134 and secondary storage device 136 via bus 138. Secondary storage device 136 includes an optical and/or magnetic data storage medium that bears instructions, for execution the one or more processors 130. The instructions constitute a software product 132 that when executed causes computer system 120 to implement the method described above with reference to FIG. 6. It will be realised by those skilled in the art that the programming of software product 132 is straightforward given a method according to an embodiment of the present invention that has been described herein.

Apart from comprising a personal computer, as described above with reference to FIG. 7, the computational device may also comprise, without limitation, any one of a personal digital assistant, a diagnostic medical device or a wireless device such as a cellular phone.

The embodiments of the invention described herein are provided for purposes of explaining the principles thereof, and are not to be considered as limiting or restricting the invention since many modifications may be made by the exercise of skill in the art without departing from the scope of the invention as defined by the following claims.

1. A method of operating at least one computational device to enhance extraction of information associated with a first training set of vectors, the method including operating said computational device to perform the step of:
(a) forming a plurality of mutually orthogonal training sets from said first training set.

2. A method according to claim 1 further including the step of:
(b) training each of a plurality of decision machines with a corresponding one of the plurality of mutually orthogonal training sets.

3. A method according to claim 2, further including the step of:
(c) extracting information about one or more test vectors with reference to the plurality of decision machines.

4. A method according to claim 2, wherein the plurality of decision machines comprises a plurality of support vector machines.

5. A method according to claim 3, wherein the plurality of decision machines comprises a plurality of support vector machines and wherein the step of extracting information comprises classifying the one or more test vectors with reference to the plurality of support vector machines.

6. A method according to claim 1, wherein step (a) includes:
(i) centering and normalizing the first training set.

7. A method according to claim 1, wherein step (a) includes:
(ii) iteratively solving a minimization problem with respect to a floating vector and with reference to the first training set to thereby determine a feature selection vector;
wherein iterations of the floating vector are derived from previous iterations of the feature selection vector so that an iteration of the floating vector and a previous iteration of the feature selection vector are orthogonal.

8. A method according to claim 7, wherein the minimization problem comprises a least squares problem.

9. A method according to claim 7, wherein step (a) further includes:
(iii) setting elements of the features selection vector to zero in the event that they fall below a threshold value.

10. A method according to claim 9, wherein step (a) further includes:
(iv) setting elements of a next iteration of the floating vector to zero in the event that they correspond to above-threshold elements of a current iteration of the feature selection vector.

11. A method according to claim 7, wherein step (a) further includes:
(v) applying iterations of the feature selection vector to the first training set to thereby form the plurality of mutually orthogonal training sets.

12. A method according to claim 7, wherein step (a) further includes:
flagging termination of the method in the event that at least a predetermined number of elements of the feature selection vector are less than a predetermined tolerance.

13. A method of operating at least one computational device to enhance extraction of information associated with a first training set of vectors, the method including operating said computational device to perform the step of:
(a) forming a plurality of mutually orthogonal training sets from said first training set;
(b) training each of a plurality of classification support vector machines with a corresponding one of the plurality of mutually orthogonal training sets; and
(c) classifying one or more test vectors with reference to the plurality of classification support vector machines.

14. A computer software product in the form of a media bearing instructions for execution by one or more processors, including instructions to implement a method according to claim 1.

15. A computer software product in the form of a media bearing instructions for execution by one or more processors, including instructions to implement a method according to claim 13.

16. A computational device programmed to perform the method of claim 1.

17. A computational device programmed to perform the method of claim 13.

18. A computational device according to claim 1 comprising any one of:
a personal computer;
a personal digital assistant;
a diagnostic medical device; or
a wireless device.

19. A method according to claim 1, further including:
programming at least one computational device with computer executable instructions corresponding to step (a) and storing the computer-executable instructions on a computer readable media.

20. A method according to claim 13 including:
programming at least one computational device with computer executable instructions corresponding to steps (a), (b) and (c) and storing the computer executable instructions on a computer readable media.
